(19) United States
(12) Patent Application Publication
(10) Pub. No.: US 2016/0343071 A1
(43) Pub. Date: Nov. 24, 2016

(54) SYSTEMS AND METHODS FOR GENERATING COMMUNICATION DATA ANALYTICS

(71) Applicant: Prattle Analytics, LLC, St. Louis, MO (US)

(72) Inventors: Evan Albert Schnidman, Upton, MA (US); William David MacMillan, St. Louis, MO (US)

(21) Appl. No.: 15/157,801

(22) Filed: May 18, 2016

Related U.S. Application Data
(60) Provisional application No. 62/163,729, filed on May 19, 2015.

(51) Int. Cl. G06Q 40/02; G06F 17/30

(52) U.S. Cl. CPC G06Q 40/02; G06F 17/3053; G06F 17/30873; G06Q 50/18

(57) ABSTRACT

Electronically-imaged financial data and/or communications data is often produced in un-interpretable format, natural-language format, and/or the like, any of which cannot be easily interpreted and automatically analyzed by a computer. The present application involves systems and methods for more efficient processing such data.

### CROSS REFERENCE TO RELATED APPLICATIONS

The present non-provisional utility application claims priority under 35 U.S.C. §119(e) to co-pending provisional application No. 62/163,729 entitled “Systems And Methods For Generating Communication Data Analytics,” filed on May 19, 2015, and which is hereby incorporated by reference herein.

### TECHNICAL FIELD

Aspects of the present disclosure relate to data analysis, and in particular, to computing systems that automatically monitor, manage, and analyze central bank communications data received from central bank computing systems, or other computing devices and systems.

### BACKGROUND

Historically, central banks have been uncommunicative and secretive about their operations. In years past, however, central banking practice has shifted from secrecy to greater transparency, with respect to their positions on monetary policy, strategy and objectives. As central banks become more communicative, interested parties have attempted to interpret and analyze any information provided by the banks in an effort to understand how the policies may affect their positions and expectations.

Conventional central bank communication analysis requires human-intervention and manual processing by interested parties, such as economic experts. For example, economic experts are often used to manually pre-identify the rules by which central bank communications information may be analyzed. Moreover, the central bank communications information used in a typical analysis performed by a given economic expert only represents a small subset of the data provided by the central banks. Such conventional methods of analyzing central banking communications are expensive, labor-intensive, and time consuming.

It is with these concepts in mind, among others, that various aspects of the present disclosure were conceived.

### SUMMARY

Aspects of the present disclosure include methods, systems, and computer-readable mediums for generating central bank analytics from electronically-imaged documents. The methods, systems, and/or computer-readable mediums include receiving central bank communications data from a central bank system computing device, the central bank communications data including a plurality of documents, the documents electronically-imaged and pre-stored at the central bank system. The methods, systems, and/or computer-readable mediums further include scraping the plurality of central bank documents by: transforming each electronic document into a standardized data format and based on the standardized data format, extracting text from each document of the plurality of documents. The methods, systems, and/or computer-readable mediums include calculating a document score for each document of the plurality of documents, based on the extracted text of the document. The methods, systems, and/or computer-readable mediums include calculating at least one analytic by averaging document scores corresponding to respective documents of the plurality of documents.

### BRIEF DESCRIPTION OF THE DRAWINGS

The foregoing and other objects, features, and advantages of the present disclosure set forth herein will be apparent from the following description of particular embodiments of those inventive concepts, as illustrated in the accompanying drawings. Also, in the drawings the like reference characters refer to the same parts throughout the different views. The drawings depict only typical embodiments of the present disclosure and, therefore, are not to be considered limiting in scope.

FIG. 1 is a flowchart illustrating an example process for generating central bank analytics, according to aspects of the present disclosure.

FIG. 2 is block diagram illustrating a computing environment for generating central bank analytics, according to aspects of the present disclosure.

FIG. 3 is a flowchart illustrating an example process for processing central bank communications data, according to aspects of the present disclosure.

FIG. 4 is a diagram of a computing system, according to aspects of the present disclosure.

### DETAILED DESCRIPTION

Aspects of the present disclosure provide a data processing analytics system/platform that automatically enables users to monitor, manage, and interpret various pieces of data related to central bank communications, central bank policies, macroeconomic trend data, and/or the like (referred to herein as “central bank communication data”). In various aspects, the analytics platform may execute one or more algorithms that output a quantitative measure of the value (e.g., sentiment) of the central bank communication data. More specifically, the analytics system processes the content of all, or nearly all, central bank communications communicated by or otherwise associated with a particular central banking system over a given period and generates unbiased score values for each communication. The scores of each communication are then processed to generate an overall analytic, such an index that reflects the sentiment of the entire central bank system in the form of a time series representing each document score coupled with date/time information as well as additional metadata.

In other aspects, one or more interactive interfaces, graphical-user interfaces, dashboards and/or portals may be generated that enable users to access the one or more central bank analytics that identify and/or quantify potential issues corresponding to each central bank individually, or central banks collectively. The various interactive interfaces are dynamically driven by data received from monitoring devices associated with central banks. Using the central bank communication data to dynamically drive the interfaces automatically enables the data processing analytics platform to generate central bank analytics that may be provided to users to monitor and manage banks, central banks, intermediate banks, etc., with minimal human intervention, effectively reducing the cost and time delays typically associated with providing such analytics and reports to users.

The various concepts described herein involve configuring various computing devices in a particular way to implement specific algorithms that perform the particular task of efficiently and instantly processing vast amounts of electronically-imaged financial data and/or central bank communication data and subsequently generate real-time analytics. Electronically-imaged financial data and/or communications data is often produced in un-interpretable format, natural-language format, and/or the like, any of which cannot be easily interpreted and automatically analyzed by a computer. Stated differently, conventional methods used to process such data to automatically extract relevant text and material cannot be done in real-time, unless the data is structurally re-arranged in a standardized data format to enable more efficient processing and interpretation, as described herein. And human interpretation of such material would be too expensive, time-consuming, and result in numerous errors. Accordingly, the various systems and methods described herein involve various algorithms that automatically process, parse, and/or interpret financial data and communications in a real-time and efficient manner. Moreover, implementing the algorithms described herein enables disparate pieces of financial data and/or communications data to be automatically aggregated and processed in real-time, resulting in more accurate analytic generation.

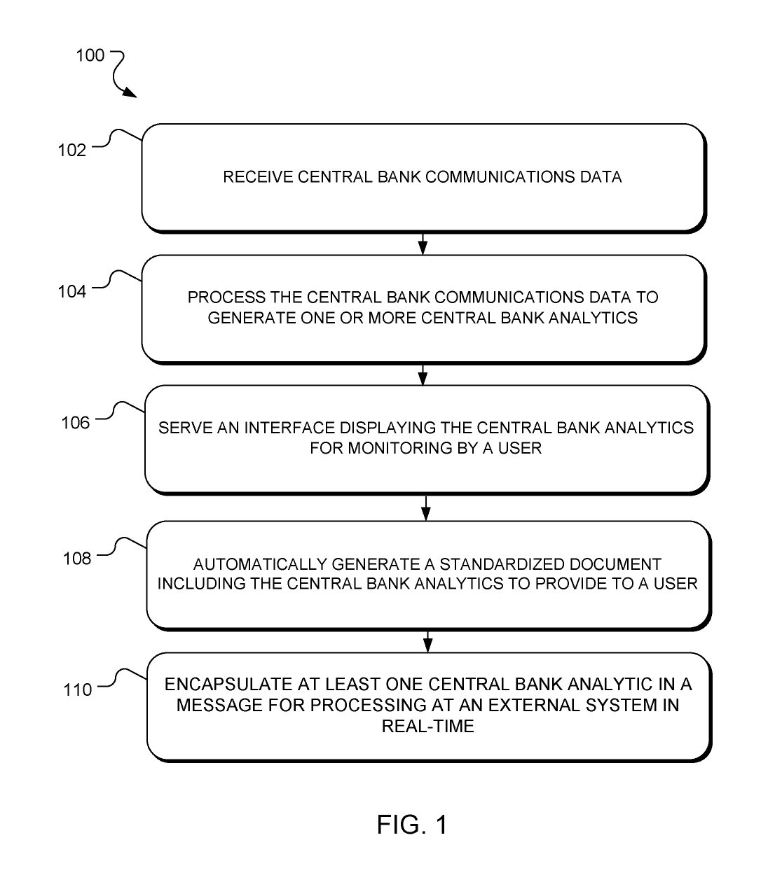

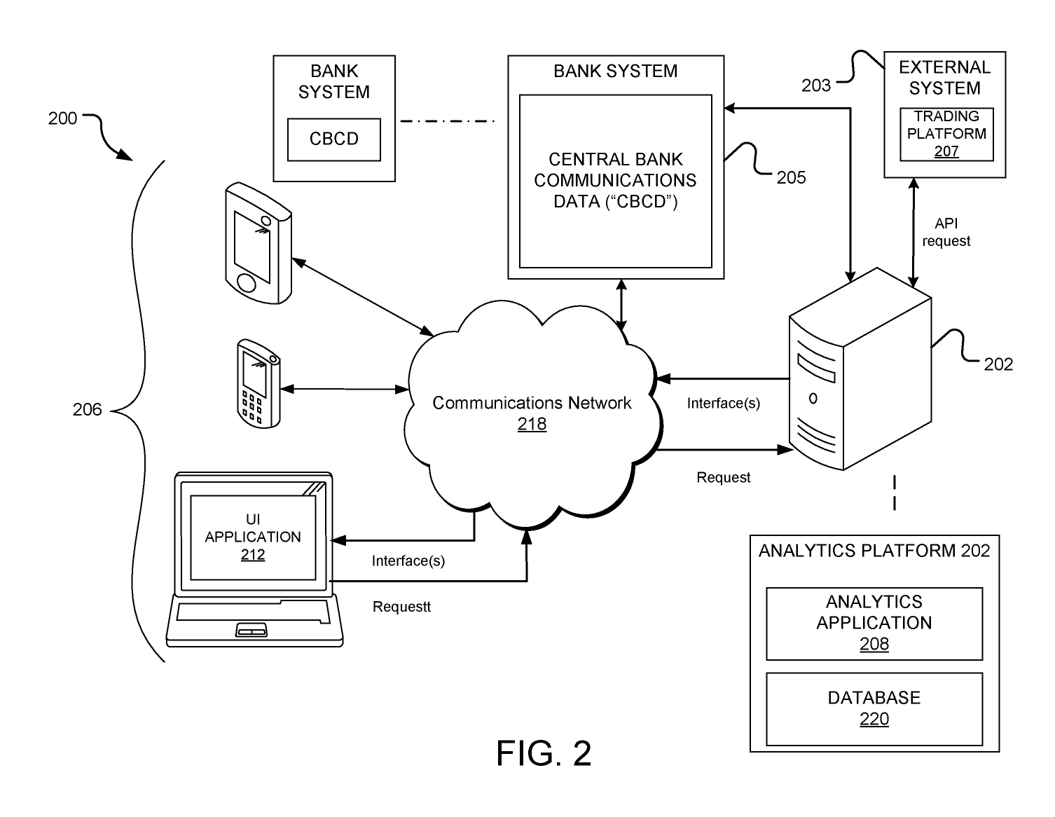

An illustrative process and system for providing or otherwise generating central bank analytics for automatic and real-time integration into various web-based platforms, is depicted in FIGS. 1-2. In particular, FIG. 1 illustrates an example process 100 for generating one or more central bank analytics and subsequent integration into various web-based platforms and/or other communication computing systems. FIG. 2 illustrates a networked computing environment 200 including an analytics platform 202 configured to generate and/or otherwise provide access to one or more interfaces (e.g., graphical user-interfaces, web portals) capable of displaying the various central bank analytics that enable users to monitor and manage central banks, communications received from central banks, central bank analytics, among others. More specifically, FIG. 2 illustrates a computing environment 200 including the analytics platform 202 operating in conjunction with various other hardware and/or software components may be used to perform or otherwise execute the process 100.

Referring now to FIG. 1, process 100 begins with identifying one or more documents, data sets, and/or the like, involving central bank communications that may be analyzed by the analytics platform 202 (operation 102). More particularly, as illustrated in FIG. 2, central bank communication data may be collected from a central bank system 205 and/or the various components included within the central bank system 205. For example, the central bank communication data may come in the form of speech documents, meeting minutes, press release documents, congressional documents including testimony files, research papers, aggregate information reports (i.e. “books” such as the Beige Book), policy proclamations, public notifications of action, press conference transcripts, question and answer transcripts, among others.

In one embodiment, the central bank communication data may be received or otherwise identified at the analytics platform 202 according to a pre-determined temporal interval, periodically, or in real-time to enable immediate and instantaneous processing of the central bank communication data that could not otherwise occur. In another embodiment, the central bank communication data may be received in accordance with an instruction by a user interacting with an interactive interface of the analytics platform 202 to gather such data. In yet another embodiment, the central bank communication data may be pushed on a schedule (or due to events) or in immediate response to requests from other external systems, such as external system 203. It is contemplated that central bank communication data collection and reception may be triggered by any number of events.

The central bank communications data may be received by the analytics platform 202, which may be a personal computer, work station, server, mobile device, mobile phone, processor, and/or other type of processing device and may include one or more processors that process software or other machine-readable instructions. The analytics platform 202 may further include a memory to store the software or other machine-readable instructions and data and a communication system to communicate via a wireline and/or wireless communications, such as through the Internet, an intranet, and Ethernet network, a wireline network, a wireless network, and/or another communication network. The analytics platform 202 may include or be connected with a database 220, which may be a general repository of data including data, central bank communications data and/or any other data relating to central banks, banks, and generating analytics related to central banks. The database 220 may include memory and one or more processors or processing systems to receive, process, query and transmit communications and store and retrieve such data. In another aspect, the database 220 may be a database server. As illustrated in FIG. 2, the central bank communications data may be received by the analytics system 202 remotely via the communications network 218, or directly via direct communication.

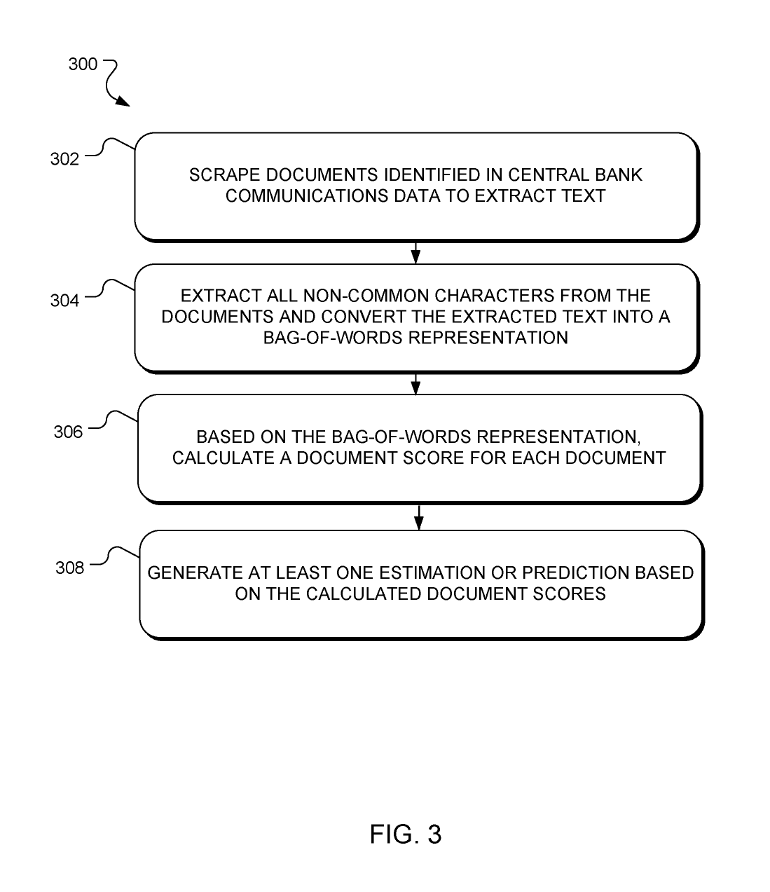

Referring again to FIG. 1, once any central bank communications data has been received, the analytics platform 202 may process the central bank communications data to generate various central bank analytics (operation 104). More particularly, the analytics platform 202 may execute various algorithms and/or processes of the analytics application 208 that transforms the central bank communications data into a data analytic, and automatically restructures and/or otherwise stores the generated analytic in a format that is interpretable by the external system 203, or elsewhere. FIG. 3 provides an example process for processing central bank communications data to generate central bank analytics, according to one embodiment. As illustrated, process 300 begins with scraping the received central bank communications data to extract text from the documents for processing (operation 302). Stated differently, each of the documents of the central bank communications data is automatically analyzed to extract text data from the documents in a raw form. In one embodiment, to scrape the central bank communications data, central bank communications data may initially be reformatted and/or otherwise automatically transformed into in a standardized text format, such as Hyper Text Markup Language (“HTML”) Extendible Markup Language (“XML”) and/or the like. Then the reformatted documents are scraped to capture all of the available text. In another embodiment, metadata corresponding to the document, including temporal information, such as such as date and time published, author, and title, for each document data may be recorded. The metadata may include data indicating when each document was made publically available, the metadata corresponding to a uniform resource locator of the document and a type of communication of the document. The scraped data may be stored in a database in raw form, a parsed representation where all visible text, and a bag of words presentation, as will be described below. In some embodiments, the additional meta-data as strings as numeric values may be stored in a database.

Each document is processed to remove common “stop” words, and unusually rare words. Subsequently, the documents may be transformed into bag-of-words representation (operation 304). Generally speaking, a bag-of-words model is a natural language processing computational model that represents a stream of text (such as a sentence or text) as a bag (e.g., multiset) of its words, disregarding grammar (e.g., sentences, paragraphs, and sections) and multiplicity. Instead, the document is represented as a vector data structure that maintains a count for each distinct word. The following provides an example as to how a bag-of-words representation may be modeled to text of two documents:

(1) Chris likes to watch basketball. Emily likes basketball too.

(2) Chris also likes to watch soccer games.

Based on these two text documents, a list is constructed as follows:

[“Chris”, “likes”, “to”, “watch”, “basketball”, “also”, “soccer”, “games”, “Emily”, “too”]

The list has 10 distinct words. Using the indexes of the list, each document is represented by a 10-entry vector:

(1) [1, 2, 1, 1, 2, 0, 0, 0, 1, 1]

(2) [1, 1, 1, 1, 0, 1, 1, 1, 0, 0]

Each entry of the vectors refers to count of the corresponding entry in the list. For example, in the first vector (which represents document 1), the first two entries are “1, 2”. The first entry corresponds to the word “Chris” which is the first word in the list, and its value is “1” because “Chris” appears in the first document 1 time. Similarly, the second entry corresponds to the word “likes” which is the second word in the list, and its value is “2” because “likes” appears in the first document 2 times. Thus, each element in this vector is a specific word, usually noted by position in the vector, and the value of the element is a real number that is the frequency, either relative or absolute, of that word in a given document.

Referring again to FIG. 3, a document score is generated for each document, based on the bag-of-words representation. More specifically, to calculate a document score, a mapping of the word frequencies—as defined by the vectors—of the documents onto non-reference documents is generated. More specifically, individual words are used to create a term frequency matrix based on word choice across documents.

In one specific example, the document scores for each document may be calculated according to a three step process. The first step, which is done once, is to select reference documents and assign scores to each document. As a part of this step, an unstandardized individual word weighting is calculated from the words present in the reference documents and the reference scores.

In the second step, the unstandardized scores of the non-reference documents are calculated (i.e. the sum of the word weighting multiplied by the relative frequency of a word in a given document, summed over the set of potentially available words for that given document). In the third step, statistics of the set of unstandardized scores are calculated to produce a set of standardized scores. In particular, the mean and standard deviation of the unstandardized scores is calculated. A final document score is generated, which is the unstandardized score for a document, minus the mean of the unstandardized scores. This difference is multiplied by the ratio of the standard deviation of the reference documents, divided by the standard deviation of the unstandardized documents. This figure then has the mean of the unstandardized documents added back into the number. This produces a final standardized score, which is close to a standard normal distribution.

The calculated document scores are considered to be a numeric reconstruction and/or quantification of a bank's position on monetary policy. For example, negative scores may indicate negative sentiment likely to lead to “dovish” monetary policy, while positive scores indicate positive sentiment likely to lead to “hawkish” monetary policy. By virtue of the design and the empirical sample, each score ranges between approximately negative two and positive two, serving as two standard deviations from the mean. In some embodiments, the range and distribution of the numbers may be assumed. The variance in the score is not assumed, and comes from the information in the documents.

In one embodiment, the location of individual documents and information on the timing of documents is recorded along with the document scores, thereby transforming the document scores to a sentiment index. In one embodiment, the scores may be averaged by day (e.g., average daily document scores), and the overall trend of sentiment is smoothed using a moving average or a lowess regression. A second set of standard errors are derived for the daily sentiment measure, based on the standard errors from the smoothing method. Other methodologies may also be applied, such as moving averages of multiple types, along with splines and/or other methods of smoothing. After scoring, structural transformation of the scores is performed, based on time and smoothing of the documents scores, to generate a set of numbers that include the contemporaneous value of the sentiment index and the standard errors around the contemporaneous value.

In another embodiment, the scores are combined with metadata regarding individual documents and information on asset prices to create indexes specific to trading scenarios. The document scores may be weighted by the impact select speakers (as identified in the document) or types of documents have on markets, to create alternate constructions of the scores. The metadata can pertain to a number of features of individual documents, including the author(s), the date and time it was released, the nature of the communication (i.e. speech versus a press release) or the subject matter of the communication.

The generated scores are used to generate a series of predictions or estimations including estimations of upcoming changes to markets and forward predictions of documents (operation 308). In various embodiments, the analytics system may predict when: bond yields, equities prices, currency strength, commodities prices, and other systematic economic variables influenced by the macro-economy, will change.

Referring back to FIG. 1, one or more interactive interfaces/input forms (e.g. a user-interface or graphical user-interface (GUI)) may be generated for displaying the calculated central bank analytics (operation 106). In particular, the analytics platform 202 of FIG. 2 may provide a mechanism, process, and/or application, such as the analytics application 208, which, when executed, generates the interfaces configured to present central bank analytics. The interfaces may include interactive elements, such as buttons, forms, activity logs, fields, streaming capabilities for streaming central bank communications data, selections, inputs, streams, images, etc., charts, for displaying various central bank analytics. For example, in one embodiment, one or more web pages may be displayed that allow users to access central bank analytics in near real-time. In another embodiment, the may include various other elements, components, forms, fields, and/or selections for receiving central bank communications data corresponding to such central bank analytics. In yet another embodiment, the various interfaces may include an activity log capable of performing real-time activity logging, streaming of central bank communications data and/or central bank analytics, and the like.

A user interested in monitoring or managing various central bank analytics may interact with one or more client device(s) 206 to initiate a request, which may be received by the analytics platform 202. More particularly, the one or more client device(s) 206 may also include a user interface (“UI”) application 212, such as a browser application, to generate a request for monitoring central bank analytics. In response, the analytics platform 202 may transmit instructions that may be processed and/or executed to generate, or otherwise display, the various interfaces generated by the analytic application 208 for presenting central bank analytics (e.g. central bank communications data). The one or more client device(s) 206 may be a personal computer, work station, mobile device, mobile phone, tablet device, processor, and/or other processing device capable of implementing and/or executing processes, software, applications, etc. Additionally, the one or more client device(s) 206 may include one or more processors that process software or other machine-readable instructions and may include a memory to store the software or other machine-readable instructions and data. The one or more client device(s) 206 may also include a communication system to communicate with the various components of the analytics platform 202 via a wireline and/or wireless communications, such as through a network 218, such as the Internet, an intranet, an Ethernet network, a wireline network, a wireless network, a mobile communications network, and/or another communication network. The various interactive interfaces generated in response to a monitoring request may be displayed at the one or more client device(s) 206.

As illustrated in FIG. 1, a report, summary, or other standardized format of information may be generated from the one or more interfaces and subsequently provided to a user (operation 108). More particularly, the analytics system 202 may process any of the generated central bank analytics and subsequently inputs such data into a standardized report structure including some form of master data document populated with central bank analytics and other central bank communications data. Example embodiments include an e-mail, csv files, Internet-accessible formats such as a markup document, pdf, and the like. Any of such documents and/or reports may be transmitted from the analytics system 202 to one or more of the client device(s) 206 for access by users.

In other embodiments, the generated central bank analytics may be displayed, in real-time, in a manner that illustrates a relationship between the central bank analytics and other economic factors in real-time. For example, the other economic factors may include equity markets, macroeconomic data, bonds, and foreign currency exchange rates. For example, if a user wanted to get a visual feel for the relationship between the Federal Reserve's sentiment and Visa's stock price over the last ten (10) years, the steps to retrieve such a visualization would involve a user selecting, via the interactive interface, the Federal Reserve economic factor from a drop-down menu, thereby causing the interactive interface to automatically refreshed and re-populated with data corresponding to the Federal Reserve economic factor.

Referring back to FIG. 1, the generated central bank analytics may be encoded into a message sent to an external computing system 203 containing the automated trading platform 207 through which real-time trade-based decisions may be made, in response to an application programming interface (“API”) request, received from the external system, that requests direct access to the generated central bank analytics, or other central communications data (operation 110). For example, API requests may be submitted from the bank system 203 to the analytics platform 202 requesting access to the central bank analytics. In response, the analytics platform 202 may provide the central bank analytics to a trading platform 207 of the external system 203 in the form of discrete data packets that may be directly and automatically embedded into a currently executing trading algorithm and/or functional model of the trading platform 207 of the external system 203, and thereby impact, in real-time, the decision logic of such trading algorithms and/or functional models currently executing at the trading platform 207.

In some embodiments, to retrieve data (e.g., the central bank analytics and/or corresponding data) the external system 203 must acquire a bearer token or cookie from the analytics platform 202 by submitting a POST request including two parameters: an email corresponding to a user and a password associated with the user account. Including such authentication information enables user to submit API requests for specific data sets of the communications data and/or, central bank analytics, central bank analytical data, portions of the central bank analytics, and/or the like.

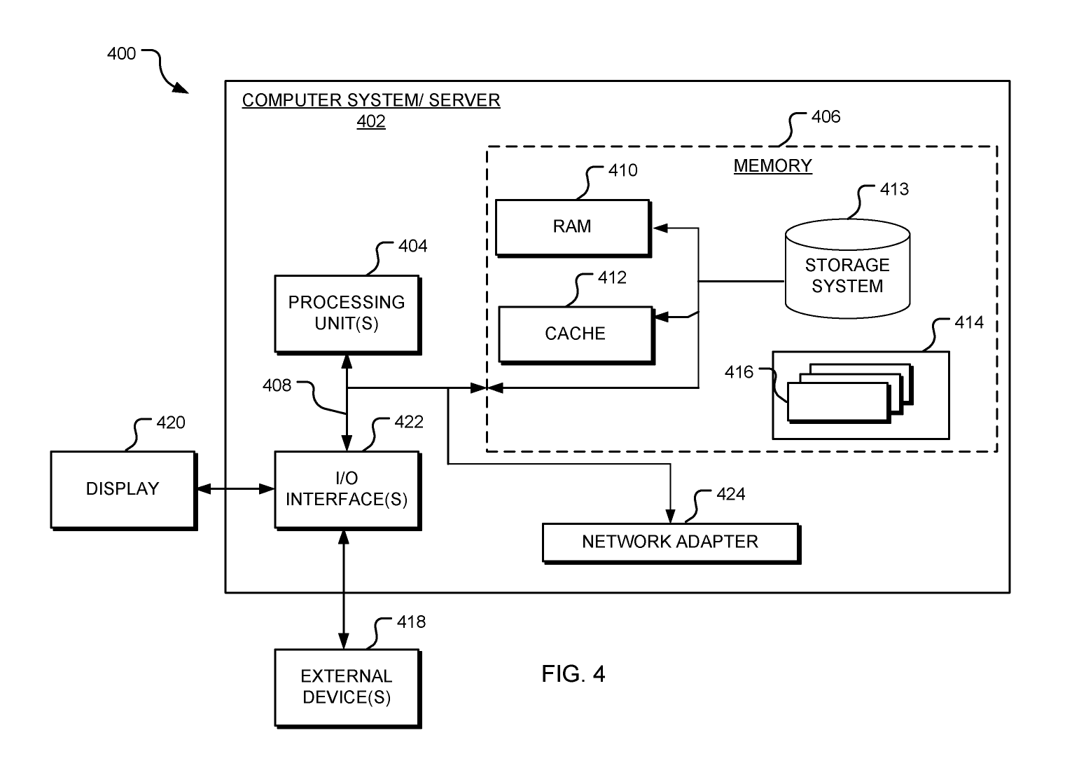

FIG. 4 is an example schematic diagram of a computing system implementing an analytics system 202 that may be used to generate central bank communication data analytics, according to one embodiment. As shown in FIG. 4, computer system/server 402 in computing node 400 is shown in the form of a general-purpose computing device. The components of computer system/server 402 may include one or more processors or processing units 404, a system memory 406, and a bus 408 that couples various system components including system memory 406 to processor 404, cameras, HUD(s), sensors, and/or the like.

Bus 408 represents one or more of any of several types of bus structures, including a memory bus or memory controller, a peripheral bus, an accelerated graphics port, and a processor or local bus using any of a variety of bus architectures. Such architectures may include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 402 typically includes a variety of computer system readable media. Such media may be any available media that is accessible by computer system/server 402, and it includes both volatile and non-volatile media, removable and non-removable media.

System memory 406 may include computer system readable media in the form of volatile memory, such as random access memory (RAM) 410 and/or cache memory 412. Computer system/server 402 may further include other removable/non-removable, volatile/non-volatile computer system storage media. By way of example only, storage system 413 can be provided for reading from and writing to a non-removable, non-volatile magnetic media (not shown and typically called a “hard drive”). Although not shown, an optical disk drive for reading from or writing to a removable, non-volatile optical disk such as a CD-ROM, DVD-ROM or other optical media may be provided. In such instances, each can be connected to bus 408 by one or more data media interfaces. As will be further depicted and described below, memory 406 may include at least one program product having a set (e.g., at least one) of program modules that are configured to carry out the functions of embodiments of the invention.

Program/utility 414, having a set (at least one) of program modules 416, may be stored in memory 406, as well as an operating system, one or more application programs, other program modules, and program data. Each of the operating system, one or more application programs, other program modules, and program data or some combination thereof, may include an implementation of a networking environment. Program modules 416 generally carry out the functions and/or methodologies of embodiments of the invention as described herein.

Computer system/server 402 may also communicate with one or more external devices 418 such as a keyboard, a pointing device, a display 420, etc.; one or more devices that enable a user to interact with computer system/server 402; and/or any devices (e.g., network card, modem, etc.) that enable computer system/server 402 to communicate with one or more other computing devices. Such communication can occur via Input/Output (I/O) interfaces 422. Still yet, computer system/server 402 can communicate with one or more networks such as a local area network (LAN), a general wide area network (WAN), and/or a public network (e.g., the Internet) via network adapter 424. As depicted, network adapter 424 communicates with the other components of computer system/server 402 via bus 408. It should be understood that although not shown, other hardware and/or software components could be used in conjunction with computer system/server 402. Examples, include, but are not limited to: microcode, device drivers, redundant processing units, external disk drive arrays, RAID systems, tape drives, and data archival storage systems, etc.

The embodiments of the present disclosure described herein are implemented as logical steps in one or more computer systems. The logical operations of the present disclosure are implemented (1) as a sequence of processor-implemented steps executing in one or more computer systems and (2) as interconnected machine or circuit engines within one or more computer systems. The implementation is a matter of choice, dependent on the performance requirements of the computer system implementing aspects of the present disclosure. Accordingly, the logical operations making up the embodiments of the disclosure described herein are referred to variously as operations, steps, objects, or engines. Furthermore, it should be understood that logical operations may be performed in any order, unless explicitly claimed otherwise or a specific order is inherently necessitated by the claim language.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements and methods which, although not explicitly shown or described herein, embody the principles of the disclosure and are thus within the spirit and scope of the present disclosure. From the above description and drawings, it will be understood by those of ordinary skill in the art that the particular embodiments shown and described are for purposes of illustrations only and are not intended to limit the scope of the present disclosure. References to details of particular embodiments are not intended to limit the scope of the disclosure.

What is claimed is:

1. A system comprising:
at least one processor to generate at least one analytic by:
receive bank communications data from a bank system computing device, the bank communications data including a plurality of documents, the documents electronically-imaged and pre-stored at the bank system;
scraping the plurality of bank documents by:
transforming each electronic document into a standardized data format; and
based on the standardized data format, extract text from each document of the plurality of documents;
calculate a document score for each document of the plurality of documents, based on the extracted text of the document;
calculate the at least one analytic by averaging document scores corresponding to respective documents of the plurality of documents.

2. The system of claim 1, wherein scraping the plurality of bank electronic documents further comprises:
for each document of the plurality of document, storing metadata identifying a date and time the document was published, a uniform resource locator of the document, and a type of communication of the document.

3. The system of claim 1, wherein the at least one processor is further configured to:
parse each document of the plurality of electronic documents to remove all non-alphabetic characters; and
subsequent to the removal of the non-alphabetic characters, transform text of the plurality of electronic documents into a bag-of-words representation.

4. The system of claim 1, wherein to calculate a document score for each document comprises:
identifying at least one reference document from the plurality of electronic documents;
assigning a reference score to the at least one reference document;
assigning a weight to each word of a plurality of words included in the at least one reference document, based on the reference score; and
wherein the document score of each document is the sum of the weight of at least one word of the plurality of words multiplied by a frequency of the at least one word appearing in the document, summed over a set of available words for the document.

5. The system of claim 1, wherein the at least one processing device is further configured to:
based on the at least one analytic, generate at least one instruction for real-time execution at an external system, wherein the at least on instruction modifies at least one real-time trading decision being executed at the external system.

6. The system of claim 1, wherein the standardized format is at least one of hypertext markup language, extensible markup language, and document object model.

7. A method comprising:
receiving bank communications data from a bank system computing device, the bank communications data including a plurality of documents, the documents electronically-imaged and pre-stored at the bank system;
scraping the plurality of bank documents by:
transforming each electronic document into a standardized data format; and
based on the standardized data format, extracting text from each document of the plurality of documents;
calculating a document score for each document of the plurality of documents, based on the extracted text of the document; and
calculating at least one analytic by averaging document scores corresponding to respective documents of the plurality of documents.

8. The method of claim 7, wherein scraping the plurality of bank electronic documents further comprises:
for each document of the plurality of document, storing metadata identifying a date and time the document was published, a uniform resource locator of the document, and a type of communication of the document.

9. The method of claim 7, further comprising:
parse each document of the plurality of electronic documents to remove all non-alphabetic characters; and
subsequent to the removal of the non-alphabetic characters, transform text of the plurality of electronic documents into a bag-of-words representation.

10. The method of claim 7, wherein to calculate a document score for each document comprises:
identifying at least one reference document from the plurality of electronic documents;
assigning a reference score to the at least one reference document;
assigning a weight to each word of a plurality of words included in the at least one reference document, based on the reference score; and
wherein the document score of each document is the sum of the weight of at least one word of the plurality of words multiplied by a frequency of the at least one word appearing in the document, summed over a set of available words for the document.

11. The method of claim 7, further comprising:
based on the at least one analytic, generate at least one instruction for real-time
execution at an external system, wherein the at least on instruction modifies at least one real-time trading decision being executed at the external system.

12. The method of claim 7, wherein the standardized format is at least one of hypertext markup language, extensible markup language, and document object model.

13. A non-transitory computer-readable storage medium encoded with instructions executable by a processor comprising:
receiving bank communications data from a bank system computing device, the bank communications data including a plurality of documents, the documents electronically-imaged and pre-stored at the bank system;
scraping the plurality of bank documents by:
transforming each electronic document into a standardized data format; and
based on the standardized data format, extracting text from each document of the plurality of documents;
calculating a document score for each document of the plurality of documents, based on the extracted text of the document; and
calculating at least one analytic by averaging document scores corresponding to respective documents of the plurality of documents.

14. The non-transitory computer-readable storage medium of claim 13, wherein scraping the plurality of bank electronic documents further comprises:
for each document of the plurality of document, storing metadata identifying a date and time the document was published, a uniform resource locator of the document, and a type of communication of the document.

15. The non-transitory computer-readable storage medium of claim 13, further comprising:
parse each document of the plurality of electronic documents to remove all non-alphabetic characters; and
subsequent to the removal of the non-alphabetic characters, transform text of the plurality of electronic documents into a bag-of-words representation.

16. The non-transitory computer-readable storage medium of claim 13, wherein to calculate a document score for each document comprises:
identifying at least one reference document from the plurality of electronic documents;
assigning a reference score to the at least one reference document;
assigning a weight to each word of a plurality of words included in the at least one reference document, based on the reference score; and
wherein the document score of each document is the sum of the weight of at least one word of the plurality of words multiplied by a frequency of the at least one word appearing in the document, summed over a set of available words for the document.

17. The non-transitory computer-readable storage medium of claim 13, further comprising:
based on the at least one analytic, generate at least one instruction for real-time execution at an external system, wherein the at least on instruction modifies at least one real-time trading decision being executed at the external system.

18. The non-transitory computer-readable storage medium of claim 13, wherein the standardized format is at least one of hypertext markup language, extensible markup language, and document object model.
